(19) United States
(12) Patent Application Publication
(10) Pub. No.: US 2008/0122306 A1
(43) Pub. Date: May 29, 2008

(54) Magnet Gear Device

(76) Inventor: Arthur Kiramidzhyan, Los Angeles, CA (US)

Correspondence Address: ITALIA IP, 3500 WEST OLIVE AVE., SUITE 300, BURBANK, CA, 91505, US

(21) Appl. No.: 11/564,287

(22) Filed: Nov. 28, 2006

(51) Int. Cl. H02K 35/00; H02K 7/06; H02K 49/00

(52) U.S. Cl. 310/80; 310/103; 310/15

(57) ABSTRACT

A magnetic gear device for converting a rotary force to a linear force, the device comprising a rotary assembly for accepting a rotary force, a linear assembly for accepting a linear force, and a magnet assembly linked to the rotary assembly sand the linear assembly for converting the rotary force to a linear force.

### BACKGROUND OF INVENTION

This application relates generally to a gear device. More specifically, this application discloses a magnet gear device that converts a rotary force to a linear force that may be used in a variety of applications such as in a hand tool or a pump.

### SUMMARY

This application discloses a magnet gear device for converting a rotary force to a linear force. The device is of simple construction and can be used in a variety of applications including in hand tools, pumps, and any other similar device where it is desirable to have a linear force as a means of accomplishing some form of work. In particular, this application discloses a magnet gear device for converting a rotary force to a linear force, said device comprising a rotary assembly including a drive axel with a magnet assembly attachment region at one end and a rotary attachment region at the other; a linear assembly including a linear shaft with a tool attachment region at one end, a magnet assembly attachment region at the other, and reciprocating means functionally coupled to said linear shaft there between a magnet assembly positioned between said rotary assembly and said linear assembly such that said rotary assembly and said linear assembly are functionally linked; and said magnet assembly including first and second magnet holders, wherein said first holder includes at least two oppositely opposed magnets, securement means to retain said magnets in said holder, and drive axle attachment means for fixedly attaching said first holder to said drive axle and wherein said second holder includes at least two oppositely opposed magnets, securement means to retain said magnets in said holder, and means for fixedly attaching said second holder to said linear shaft.

This application also discloses magnetic gear device for converting a rotary force to a linear force, said device comprising a rotary assembly means for accepting a rotary force; a linear assembly means for accepting a linear force; and a magnet assembly means linked to said rotary assembly means and said linear assembly means for converting said rotary force to a linear force.

This application further discloses an improved hand tool device comprising a body; a rotary assembly located within said body including a drive axel with a magnet assembly attachment region at one end and a rotary attachment region at the other; a linear assembly located in said body including a linear shaft with a tool attachment region at one end, a magnet assembly attachment region at the other, and reciprocating means functionally coupled to said linear shaft there between; a magnet assembly located in said body positioned between said rotary assembly and said linear assembly such that said rotary assembly and said linear assembly are functionally linked; said magnet assembly including first and second magnet holders, wherein said first holder includes at least two oppositely opposed magnets, securement means to retain said magnets in said holder, and drive axle attachment means for fixedly attaching said first holder to said drive axle and wherein said second holder includes at least two oppositely opposed magnets, securement means to retain said magnets in said holder, and means for fixedly attaching said second holder to said linear shaft.

### BRIEF DESCRIPTION OF THE DRAWINGS

The drawings, when considered in connection with the following description, are presented for the purpose of facilitating an understanding of the subject matter sought to be protected.

FIG. 1 is side plan view of the magnetic gear device disclosed herein;

FIG. 2 is a perspective view the magnetic gear device in FIG. 1;

FIG. 3 is a perspective view the magnetic gear device in FIG. 1 showing the opposite view as in FIG. 2;

FIG. 4 is an exploded view of the magnetic gear device in FIG. 1 incorporated in a hand tool shown associated with a motor; and

FIG. 5 is an enlarged, fragmentary, perspective view of the magnetic gear device in FIG. 1.

### DETAILED DESCRIPTION

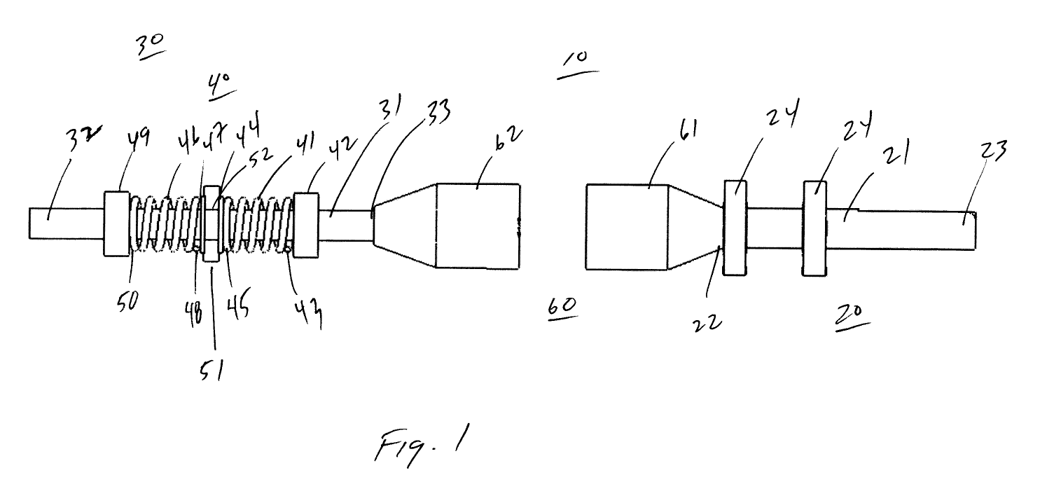

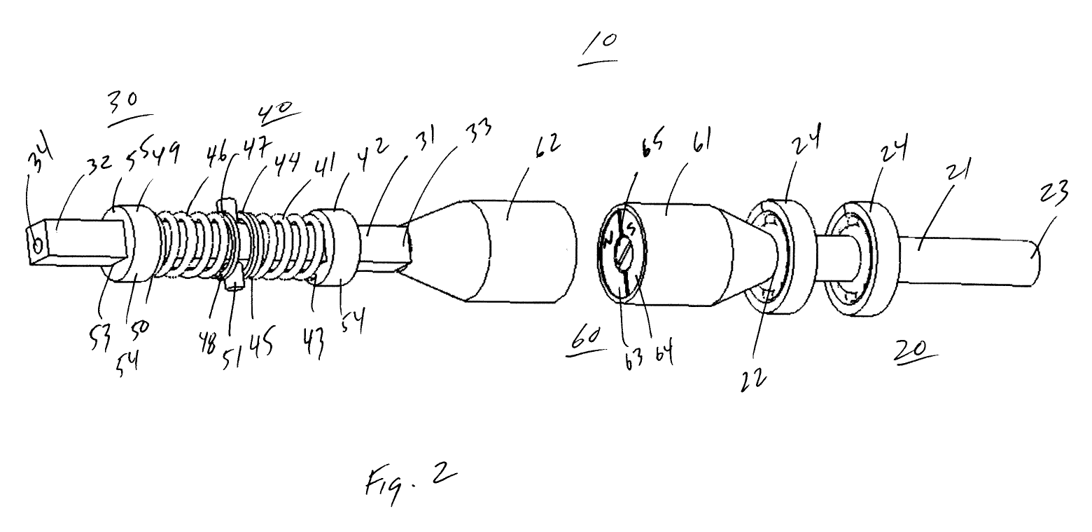

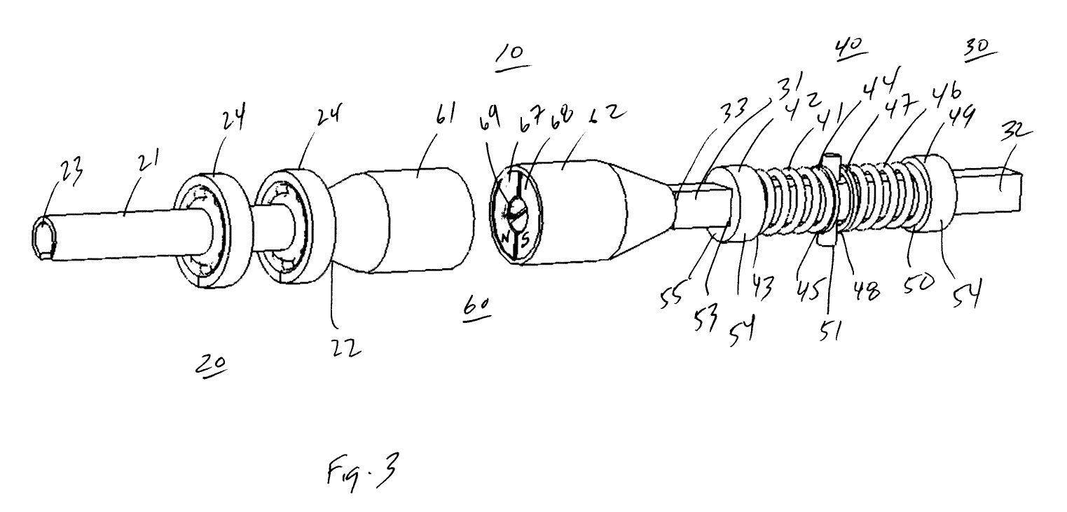

FIGS. 1-3 show the magnet gear device of the present invention. The device 10 includes a rotary assembly 20, a linear assembly 30 which includes a reciprocating assembly 40, and a magnet assembly 60.

The rotary assembly 20 includes a drive axel 21 with a magnet assembly attachment region 22 at one end and a rotary attachment region 23 at the other. The rotary assembly 20 may also include one or more bearings 24.

The linear assembly 30 includes a linear shaft 31 with a tool attachment region 32 at one end, a magnet assembly attachment region 33 at the other, and a reciprocating assembly 40 functionally coupled to the linear shaft 31 there between.

The reciprocating assembly 40 includes a first spring 41 adjacent to a first plate 42 at one end 43 and a first washer 44 at the other 45. A second spring 46 is adjacent to a second washer 47 at one end 48 and a second plate 49 at the other 50. A pin 51 is then fixedly attached in a bore 52 in the linear shaft 31 such that the pin 51 is located between the first washer 44 and said second washer 47. As shown, the pin 51 extends through the bore 52 so that a portion of the pin 51 is able to contact a portion of each washer 44 and 47. The pin 51 may be held in the bore 52 by means well known in the art including, but not limited to, welding, screw, and friction fit. The first and second plates 42 and 49 include an angular bore 53 (such as a square) so that the linear shaft 31 can be mateably received in the bore. In such an orientation, the linear shaft is prevented from rotating but still allowed to pass through. The first and second plates 42 and 49 also include on their outer surface 54 means to prevent their rotation when assembled in a final device. For example, the outer surface 54 may be hexagonal in shape so that it is mateably received by the hexagonal shaped surface on the interior of the device body. Such a “key and lock” orientation to prevent rotation is well known in the art. Other methods may be used to prevent the rotation of the plates 42 and 49 such as welding, glue, or simply secured with a pin and all such methods are contemplated as part of this disclosure. The first and second plates 42 and 49 are also fixed in position so that they may serve their additional function of providing a surface to brace the compression of their respective springs 41 and 46 during operation of the device 10. Means to fix the plates in position include abutting the surface 55 of the plates opposite the springs to the inner surface of the of the device body or fusing them or fixing them to the device body with a pin assembly as in well known in the art.

The magnet assembly 60 is positioned between the rotary assembly 20 and the linear assembly 30 such that the rotary assembly 20 and the linear assembly 30 are functionally linked (“functionally linked” is defined herein as meaning that the magnet assembly is able to link the rotary assembly and the linear assembly so that the device 10 is capable of converting a rotary force to a linear force. Referring to FIG. 5, the magnet assembly 60 includes first and second magnet holders 61 and 62. The first magnet holder 61 includes two oppositely opposed magnets 63 and 64 (“oppositely opposed” is defined herein as meaning magnets that are positioned to that their polls are in opposite direction such that they would repel rather than attract), securement means 65 (such as a screw) to retain the magnets in the holder 61, and a drive axle attachment means 66 (such as a threaded portion) for fixedly attaching the first holder 61 to the drive axle 21 at the magnet assembly attachment region 22 (such as a threaded bore). The second holder 62 includes two oppositely opposed magnets 67 and 68, securement means 69 (such as a screw) to retain the magnets in the holder 62, and linear shat attachment means 70 (such as a threaded portion) for fixedly attaching the second holder 62 to the linear shaft 31 at the magnet assembly attachment region 33 (such as a threaded bore).

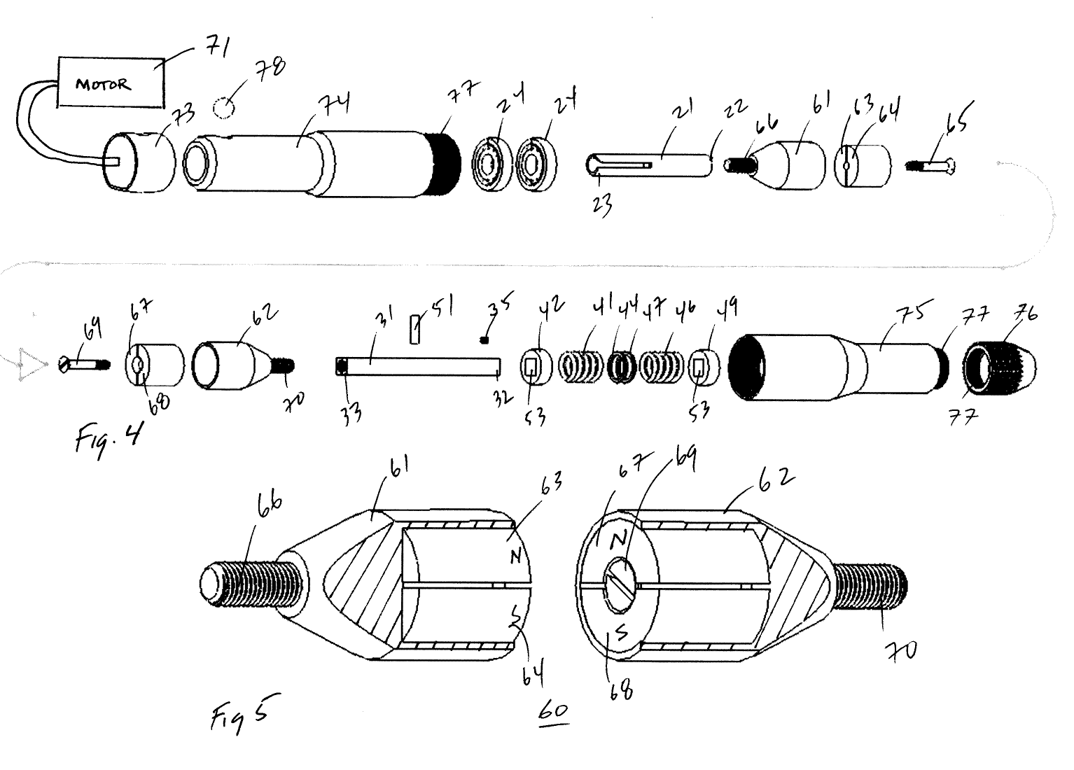

During operation, a rotary force generated by a motor 71 (see FIG. 4) is applied to the drive axel 21 at the rotary attachment portion 23. This causes the drive axel 21 to rotate in a circular motion which in turn causes the attached first magnet holder 61 and retained oppositely opposed magnets 63 and 64 to rotate. The drive axel may be supported by one or more bearings 24. This rotation creates an alternating attraction and repelling force on the second magnet holder 62 and its retained oppositely opposed magnets 67 and 68. When the poles of the magnets of each holder are opposite, the second holder 62 and attached linear shaft 31 is driven by the magnetic attraction toward the first holder 61. Likewise, when the poles of the magnets of each holder are opposite, the second holder 62 and attached linear shaft 31 is driven by the magnetic repelling force away the first holder 61. This alternating attraction and repelling force of the magnetic assembly 60 is what converts the rotary motion to a linear motion. The reciprocating assembly 40 prevents the holders 61 and 62 from coming in contact with each other during the attraction phase and prevents them from traveling too far from each other so at to fall out of range during the repelling phase. During the attraction phase, the linear shaft 31 is drawn inward, this causes the pin 51 retained in the bore 52 of the linear shaft 31 to act upon the first washer 44 which provides an even force to compress the first spring 41 against the first plate 42. During the repelling phase, the linear shaft is drawn outward, this causes the pin 51 retained in the bore 52 of the linear shaft 31 to act upon the second washer 47 which provides a even force to compress the second spring 46 against the second plate 49. Thus, one complete rotation of the drive axel 21 causes a complete reciprocal motion of the linear shaft 31. “Complete reciprocal motion” is defined herein as meaning that the linear shaft starts from one point and returns to that starting point. It should be appreciated that a device other than a pin 51 could be used. For example, an annular shaped portion could be fixedly attached to the linear shaft and thereby you would not need the washers 44 and 47 to provide and even force to the springs 41 and 46.

FIG. 4 is an exploded view of the device 10 incorporated in a hand tool. The hand tool includes a body 72 to enclose the device 10. The body includes a butt portion 73, and rotary portion 74, a linear portion 75, and a nose portion 76. The body portions are joined together by threads portions 77 as is well known in the art. The butt portion allows for the attachment of the motor 71, through the use of a lockable ball bearing 78 (as is also well known in the art), to the rotary attachment region 23 of the drive shaft 21 so that the motor can be securely attached. The tool attachment region 32 of the linear shaft 31 includes a tool attachment bore 34 suitable for receiving the engagement portion of any desired tool. A locking pin 35 is used to retain the tool in the attachment bore 34 as is well known in the art. The tools that may be attached to the tool attachment region 32 would be any such devices where it would be desirable to have a linear force as a means of accomplishing some form of work. For example, specific tools that would be desirable to attach would be a saw, hammer, file, buffer, sander, grinder, chisel and polisher. It should also be appreciated that because of the linear motion of the magnet gear device 10, it could be used in a variety of pumping devices.

In the construction of the hand tool, a majority of the components may be formed of suitable plastics that may be molded, however, the components of the magnetic gear device 10 must withstand load bearing, torsional, and other significant forces and may be formed of suitable metals. Aluminum is particularly preferred for use in the magnet holders 61 and 62.

While the present disclosure has been described in connection with what is considered the most practical and preferred embodiment, it is understood that this disclosure is not limited to the disclosed embodiments, but is intended to cover various arrangements included within the spirit and scope of the broadest interpretation so as to encompass all such modifications and equivalent arrangements.

What is claimed is:

1. A magnet gear device for converting a rotary force to a linear force, said device comprising:
a rotary assembly including a drive axel with a magnet assembly attachment region at one end and a rotary attachment region at the other;
a linear assembly including a linear shaft with a tool attachment region at one end, a magnet assembly attachment region at the other, and reciprocating means functionally coupled to said linear shaft there between;
a magnet assembly positioned between said rotary assembly and said linear assembly such that said rotary assembly and said linear assembly are functionally linked; and
said magnet assembly including first and second magnet holders, wherein said first holder includes at least two oppositely opposed magnets, securement means to retain said magnets in said holder, and drive axle attachment means for fixedly attaching said first holder to said drive axle and wherein said second holder includes at least two oppositely opposed magnets, securement means to retain said magnets in said holder, and means for fixedly attaching said second holder to said linear shaft.

2. The device of claim 1 wherein one complete rotation of said drive axel causes a complete reciprocal motion of said linear shaft.

3. The device of claim 2 wherein the reciprocating means comprises:
a first spring adjacent to a first plate at one end and a first washer at the other;
a second spring adjacent to a second washer at one end and a second plate at the other; and
a pin fixedly attached in a bore in said linear shaft such that said pin is located between said first washer and said second washer.

4. The device of claim 3 wherein said first and second plates include means to prevent said linear shaft from rotating while allowing said linear shaft to pass there through.

5. The device of claim 4 wherein the first and second plates are in a fixed position.

6. The device of claim 1 wherein the reciprocating means comprises:
a first spring adjacent to a first plate at one end and a first washer at the other;
a second spring adjacent to a second washer at one end and a second plate at the other; and
a pin fixedly attached in a bore in said linear shaft such that said pin is located between said first washer and said second washer.

7. The device of claim 6 wherein only one of said first or second springs is compressed at any one time when said linear shaft makes one complete linear motion.

8. The device of claim 6 wherein one complete rotation of said drive axel causes a complete reciprocal motion of said linear shaft.

9. A magnet gear device for converting a rotary force to a linear force, said device comprising:
a rotary assembly means for accepting a rotary force;
a linear assembly means for accepting a linear force; and
a magnet assembly means linked to said rotary assembly means and said linear assembly means for converting said rotary force to a linear force.

10. The device of claim 9 wherein one complete rotation of said rotary assembly causes a complete reciprocal motion of said linear assembly.

11. The device of claim 10 wherein the linear assembly means comprises:
a first spring adjacent to a first plate at one end and a first washer at the other;
a second spring adjacent to a second washer at one and a second plate at the other; and
a pin fixedly attached in a bore in said linear shaft such that said pin is located between said first washer and said second washer.

12. The device of claim 11 wherein only one of said first or second springs is compressed at any one time when said linear shaft makes one complete linear motion.

13. An improved hand tool device comprising:
a body;
a rotary assembly located within said body including a drive axel with a magnet assembly attachment region at one end and a rotary attachment region at the other;
a linear assembly located in said body including a linear shaft with a tool attachment region at one end, a magnet assembly attachment region at the other, and reciprocating means functionally coupled to said linear shaft there between; and
a magnet assembly located in said body positioned between said rotary assembly and said linear assembly such that said rotary assembly and said linear assembly are functionally linked;
said magnet assembly including first and second magnet holders, wherein said first holder includes at least two oppositely opposed magnets, securement means to retain said magnets in said holder, and drive axle attachment means for fixedly attaching said first holder to said drive axle and wherein said second holder includes at least two oppositely opposed magnets, securement means to retain said magnets in said holder, and means for fixedly attaching said second holder to said linear shaft.

14. The hand tool device of claim 13 wherein a tool is capable of being detachably fixed at said attachment region of said linear shaft and wherein said tool is selected from the group consisting of a saw, hammer, file, buffer, sander, grinder, chisel and polisher.

15. The device of claim 14 wherein the reciprocating means comprises:
a first spring adjacent to a first plate at one end and a first washer at the other;
a second spring adjacent to a second washer at one and a second plate at the other; and
a pin fixedly attached in a bore in said linear shaft such that said pin is located between said first washer and said second washer.

16. The device of claim 15 wherein said first and second plates include means to prevent said linear shaft from rotating while allowing said linear shaft to pass there through.

17. The device of claim 16 wherein the first and second plates are in a fixed position.

18. The hand tool device of claim 17 wherein one complete rotation of said drive axel causes a complete reciprocal motion of said linear shaft.

19. The hand tool device of claim 14 wherein one complete rotation of said drive axel causes a complete reciprocal motion of said linear shaft.

20. The hand tool device of claim 14 further comprising a motor capable of generating a rotary force and wherein said motor is capable of attaching to said rotary axel at said rotary attachment region.
